(19) United States
(12) Patent Application Publication
(10) Pub. No.: US 2004/0196160 A1
(43) Pub. Date: Oct. 7, 2004

(54) Face support control system

(75) Inventor: Johannes Wesselmann, Dortmund (DE)

Correspondence Address: Robert V. Vickers, Esq., Fay, Sharpe, Fagan, Minnich & McKee, LLP, Seventh Floor, 1100 Superior Avenue, Cleveland, OH, 44114-2579, US

(73) Assignee: DBT Automation GmbH

(21) Appl. No.: 10/800,063

(22) Filed: Mar. 12, 2004

(30) Foreign Application Priority Data
Apr. 1, 2003 (DE) 20305309.5

(51) Int. Cl. G08C 19/22; E03B 1/00; F17D 1/00; E03C 1/00

(52) U.S. Cl. 340/870.07

(57) ABSTRACT

Disclosed is a face support control system as used in conjunction with an underground mining system. The mining system generally includes a mining machine, a conveyor, one or more support shields, an array of control devices for controlling the operation of the support shields, one or more communication devices in communication with the support shields, and a face master control. The control system utilizes radio communication between the communication devices and the face master control.

### FIELD OF THE INVENTION

The present invention relates to a control system for a self-advancing face support as used in underground mining, and particularly, in longwall face mining. The face support is generally used in conjunction with a conveyor and a mining machine, and includes a plurality of support shields. Each of the support shields is associated with a control device for controlling the operation of the support shields, a communication device for interconnection of the control devices, a face master control arranged outside the face, and a communication system for transmitting data between the control devices in the longwall face and the face master control outside the face.

### BACKGROUND OF THE INVENTION

In the face support control system known from DE 198 47 901 C1, herein incorporated by reference, the communication device for interconnection of the control devices, and the communication means of the control devices with the face master control each consist of a face bus designed like the so-called PROFIBUS. All data is exchanged in the order for bus access rights established for the bus system. By using a PROFIBUS, the expense of cabling in the underground face can be reduced by about 40% as compared with conventional cable engineering. However, all control devices still need to be wired to each other and to the face master control.

DE 199 25 721 A1, herein incorporated by reference, filed by the applicant discloses an actuation of individual control devices of an underground face support by means of an infrared remote control, which the miner carries as a hand-held control device. A radio transmission and receiving unit is associated not with each individual support control unit but only with one group of support control devices to be able to exchange data by means of infrared radio transmission between the hand-held control device and the control devices.

DE 100 18 481 A1, herein incorporated by reference, discloses to transmit the condition data of the mining machine by radio via a transmitter moving with the mining machine to radio receivers arranged at a distance from each other in the face and connected to each other by a cable line system. Data is transmitted in one direction from the mining device to the face master control, and a cabled line system is arranged between individual control devices of the shield projections and the face master control.

DE 100 18 597 A1, herein incorporated by reference, discloses a face control system in which control means with a radio receiver and an infra-red transmitter are associated with individual shield control devices in the face to give the miner the possibility of actuating a support shield by radio. The miner's hand-held control device has a display on which the operating conditions of each shield can be displayed. The shield controls are connected to each other by a cabled line system.

An object of the invention is to further reduce the expense of cabling for an underground face support control system and to increase the safe function and reliability of the face support control system.

### SUMMARY OF THE INVENTION

In a first aspect, the present invention provides a face support control system for a self-advancing face support in underground mining with a conveyor, a mining machine, a plurality of support shields, each of which is associated with a control device for controlling the function of the support shields, a communication device for interconnection of the control devices, a face master control arranged outside the face and a communication system for transmitting data between the control devices in the face and the face master control outside the face. The communication system comprises a first face sided radio transmission device and a second face master control sided radio transmission device. The radio transmission devices each have receiver and transmitter modules used to carry out wireless and cable free bidirectional data transmission in the end region of the face.

In another aspect, the present invention provides a face support control system adapted for use in an underground mining system including a conveyor, a mining machine, a plurality of support shields, a plurality of control devices for controlling the operation of the support shields, at least one communication device in communication with at least one of the plurality of control devices, and a face master control. The face support control system comprises a communication system providing radio communication between the at least one communication device and the face master control.

In yet another aspect, the present invention provides a mining system comprising a mining machine adapted to remove material from a face. The mining system further comprises a plurality of support shields proximate the mining machine. The mining system also comprises a plurality of control devices for controlling the operation of the support shields. The mining system further comprises at least one communication device in communication with at least one of the plurality of control devices. The mining system also comprises a face master control. And, the mining system comprises a radio-based communication system providing radio communication between the at least one communication device and the face master control.

### BRIEF DESCRIPTION OF THE DRAWINGS

Further advantages and configurations of the face support control system according to the invention will become apparent from the following description of embodiments shown schematically in the drawings, in which:

FIG. 1 represents a first embodiment of a face support control system according to the invention; and

FIG. 2 represents a second embodiment of a face support control system according to the invention.

### DETAILED DESCRIPTION OF THE PREFERRED EMBODIMENTS

The previously noted object of the invention is achieved in that the communication system comprises at least one face sided radio transmission device and one face master control sided radio transmission device. Each of these devices both have receiver and transmitter modules used to carry out wireless and cable-free bi-directional data transmission in the end region of the face, especially in the face-gate intersections. According to the invention, the bus or bus cable connection between the face master control and the control devices or the communication device in the face connecting the control devices for data exchange, is replaced by radio transmission used to transmit data about control and condition in both directions. This feature has the particular advantage in that there is no need for cable or connection lines in particularly dangerous face end regions in which the main and auxiliary drives for the mining machine and the conveyor are mounted. The result is that there is no longer a risk in these very dangerous areas of cable or line failure and, consequently, no risk of interruptions in data exchange.

In a preferred embodiment, the one face sided radio transmission device is arranged on one face edge or two face sided radio transmission devices are arranged on the two face edges, respectively, to keep the radio transmission path in the face end area to a minimum.

In a particularly advantageous embodiment of a face support control system according to the invention, the communication device in the face comprises a radio transmission system with transmission and receiver modules spaced two or more support shields from each other. Bi-directional data exchange of control and condition data of individual or groups of support shields is possible using the radio transmission system, and there is no need for the redundant bus connections as has been previously installed in underground faces. The radio transmission system can also be used to communicate rapidly in both directions between the two ends of the face.

Another advantageous embodiment of a face support control system according to the invention is characterized in that there is associated with the mining machine a radio transmission system with a transmission and receiver module for bi-directional transmission of control and condition data to the face sided radio transmission system located on the end of the face or, if the face is very wide, to the radio transmission system integrated into the communication device. For this purpose, a control device attached to the communication device in the face is associated with the mining machine to evaluate the control data and the condition data available when data is exchanged and to synchronise them with the control data for the support shields.

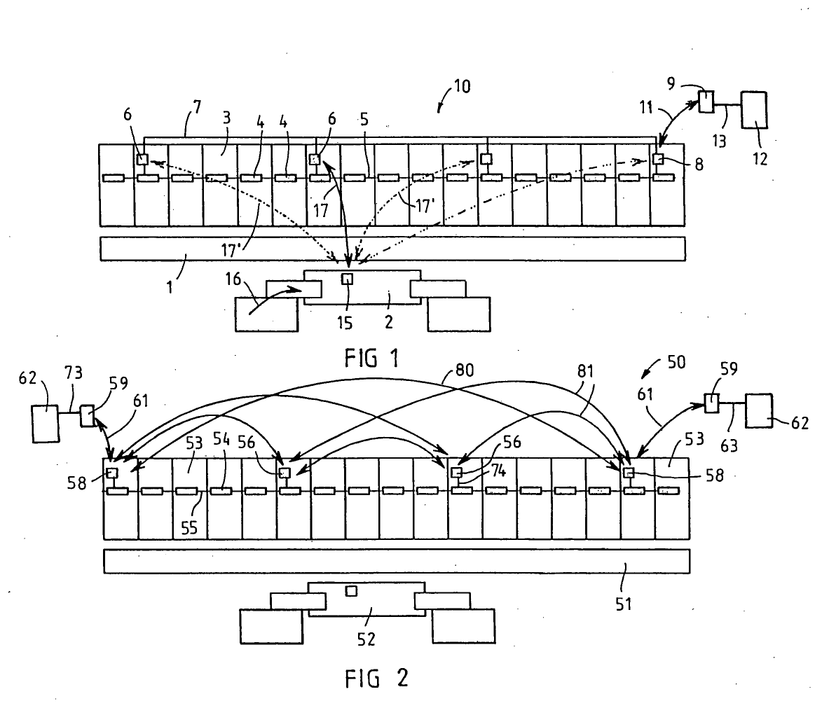

In FIG. 1, reference number 10 designates a preferred embodiment face support control system as used in an underground self-advancing mining system. The mining system mounted in the face includes, and shown schematically, a conveyor 1, a mining machine 2 shown here as a shearer, which can be displaced between the left face edge and the right face edge and is preferably supported on the conveyor 1, and a plurality of adjacent support shields 3. A control device 4 is associated with each support shield 3 to be able to carry out the individual functions of the support shield 3, such as setting or drawing, advancing the conveyor 1 by extending a pusher cylinder, or bringing up the support shield when the lifting prop and supporting shields are drawn off.

For mining safety reasons, each particular shield 3 is controlled by a control device 4, which is mounted on a neighboring shield. The individual control devices 4 are connected to each other via a connection line 5 in the form of a cabled communication device to exchange information between adjacent control devices 4. A data transmission unit or system 6 is associated with each sixth (as shown) or respectively, for example, each tenth shield 3. The individual spaced data transmission units 6 are connected to each other via a redundant ZBUS connection line 7 for data exchange. A transmission unit 8 arranged on the right face edge in FIG. 1 takes the form of a radio transmission device with receiver and transmission modules to transmit data via the bi-directional, wireless and cable-free radio transmission represented by arrow 11 to a face master control 12 set up, for example, on the surface. The face master control 12 is connected via suitable, in this case, cabled data transmission lines 13 to a second face master control sided radio transmission device 9, which device is preferably located as close as possible to the face edge and also comprises receiver and transmission modules to guarantee bi-directional radio data transmission 11 between the two radio transmission devices 8, 9. Radio data transmission 11 therefore spans the face end region, where the main and auxiliary drives for the conveyor 1 or the mining machine 2 are set up (not shown) and the risk of cable damage or tears is particularly high.

The embodiment of FIG. 1 also shows that the mining machine 2 can optionally be provided with a radio transmission station 15, which can be used to transmit to the transmission system 6 by radio connection 17 the control data and condition data of the mining machine 2 and also condition data such as rock type and rock hardness, which is determined by sensors (also not shown), and as indicated by arrow 16 are forwarded to the radio transmission station 15. It should be clear that the transmission system 6 then is also equipped with receiver and transmission modules for this purpose and, for example, has the same structure as the face sided radio transmission device 8 located on the face end. Data is transmitted between the radio transmission station 15 moving with the mining machine 2 and the radio transmission units 6 that are stationary in any case with respect to the shields 3, preferably in each case only to the closest radio transmission unit 6 that is stationary with respect to the shield 3, as indicated by the filled-in line arrow 17 and the dotted-line arrows 17′. A further control device (not shown) can be associated with the mining machine.

In another preferred embodiment of a face support control system 50 as shown in FIG. 2, there is also a conveyor 51 in a face, a mining machine 52 that can be moved backwards and forwards between both face edges and a plurality of adjacent support shields 53 moving forward with the face advance, each of which is provided with a control device 54. The control devices 54 are connected to each other by a cable connection 55. A radio transmission device 58 provided with transmission and receiver modules is arranged on the left and on the right face edge respectively. Data is transmitted by radio transmission from the radio transmission device 58 to a related face master control sided radio transmission device 59. Each of the devices are also equipped with transmission and receiver modules. The data transmission is indicated by arrow 61. The two radio transmission devices 59 on the face master control side are also connected via suitable data transmission cables 63 and 73 respectively to the face master control 62 arranged on the surface. Data between the face master control 62 and the individual control devices 54 in the underground mining face can be exchanged in both directions (bi-directionally) and is exchanged partially by radio transmission in the particularly dangerous face end regions and face-gate intersections. There is arranged at particular distances extending over several shields 53, for example at every tenth shield, a radio transmission station 56, which is connected to the control devices 54 via the connection line 74 and therefore also to the communication device 55. As a result of the receiver and transmission modules of the radio transmission stations 56 and the radio transmission devices 58, bidirectional data exchange is possible by radio transmission directly between the two radio transmission devices 58, as indicated by arrow 80, between the radio transmission devices 58 and the radio transmission stations 56, as indicated by arrow 81, and also between adjacent or arbitrary radio transmission stations 56, as indicated by arrow 82. With the face support control system 50, a redundant bus connection in the face can correspondingly be discarded.

A number of modifications, which shall be covered by the scope of protection of the dependent claims, will result for a person skilled in the art from the preceding description. The face master control sided transmission devices might also be set up on the surface. Data between the transmission devices and the face master control can also be exchanged by radio. All the control devices could be wireless and connected to each other via a “wireless network” transmission system for bidirectional data exchange.

The foregoing description is, at present, considered to be the preferred embodiments of the present invention. However, it is contemplated that various changes and modifications apparent to those skilled in the art, may be made without departing from the present invention. Therefore, the foregoing description is intended to cover all such changes and modifications encompassed within the spirit and scope of the present invention, including all equivalent aspects.

I claim:

1. A face support control system for a self-advancing face support in underground mining with a conveyor, a mining machine, a plurality of support shields, each of which is associated with a control device for controlling the function of the support shields, a communication device for interconnection of the control devices, a face master control arranged outside the face and a communication system for transmitting data between the control devices in the face and the face master control outside the face, wherein the communication system comprises a first face sided radio transmission device and a second face master control sided radio transmission device, wherein the radio transmission devices each have receiver and transmitter modules used to carry out wireless and cable-free bi-directional data transmission in the end region of the face.

2. The face support control system according to claim 1, wherein the first face sided radio transmission device is arranged on one face edge, or two face sided radio transmission devices are arranged on each of the face edges.

3. The face support control system according to claim 1, wherein the communication device in the face comprises a radio transmission system with transmission and receiver modules, which are spaced a plurality of support shields from each other.

4. The face support control system according to claim 1, wherein there is associated with the mining machine a radio transmission system with transmission and receiver modules for bidirectional transmission of control and condition data to the radio transmission devices or to the radio transmission system integrated into the communication device.

5. The face support control system according to claim 4, wherein a control device attached to the communication device in the face is associated with the mining machine.

6. A face support control system adapted for use in an underground mining system including a conveyor, a mining machine, a plurality of support shields, a plurality of control devices for controlling the operation of the support shields, at least one communication device in communication with at least one of the plurality of control devices, and a face master control, the face support control system comprising a communication system providing radio communication between the at least one communication device and the face master control.

7. The face support control system of claim 6 wherein the communication device includes a first radio unit having a transmission module and a receiver module, the communication device being in radio communication with the face master control.

8. The face support control system of claim 7 wherein the communication system further includes a second radio unit having a transmission module and a receiver module, the second radio unit being in communication with the face master control, and wherein the radio communication between the at least one communication device and the face master control is achieved by radio communication between the first radio unit and the second radio unit.

9. The face support control system of claim 6 wherein the underground mining system further includes a second communication device in communication with at least another one of the plurality of control devices, wherein the face support control system provides radio communication between the face master control and the at least one communication device and the second communication device.

10. The face support control system of claim 9 wherein the face support control system provides radio communication between the at least one communication device and the second communication device.

11. The face support control system of claim 6 wherein the underground mining system further includes a radio transmission station providing radio communication between the mining machine and the at least one communication device.

12. The face support control system of claim 11 wherein the underground mining system further includes a second communication device in communication with at least another one of the plurality of control devices, the radio transmission station providing radio communication between the mining machine and both of the communication devices.

13. A mining system comprising:
a mining machine adapted to remove material from a face;
a plurality of support shields proximate the mining machine;
a plurality of control devices for controlling the operation of, and in communication with, the support shields;
at least one communication device in communication with at least one of the plurality of control devices;
a face master control; and
a radio-based communication system providing radio communication between the at least one communication device and the face master control.

14. The mining system of claim 13 further comprising:
a radio transmission station providing radio communication between the mining machine and the at least one communication device.

15. The mining system of claim 13 wherein the at least one communication device includes a first communication device and a second communication device.

16. The mining system of claim 15 wherein the radio-based communication system provides radio communication between the first communication device and the second communication device.

17. The mining system of claim 15 further comprising:
a radio transmission station providing radio communication between at least one of the first and second communication devices and the mining machine.

18. The mining system of claim 17 wherein the radio transmission station provides radio communication between (i) the first communication device and the mining machine, and (ii) the second communication device and the mining machine.
